(19) United States
(12) Patent Application Publication
(10) Pub. No.: US 2006/0278277 A1
(43) Pub. Date: Dec. 14, 2006

(54) Fluid pressure restricting valve

(76) Inventor: Jeffrey M. Carter, Anderson, IN (US)

Correspondence Address: BOSE MCKINNEY & EVANS LLP;JAMES COLES, 135 N PENNSYLVANIA ST, SUITE 2700, INDIANAPOLIS, IN, 46204, US

(21) Appl. No.: 11/440,887

(22) Filed: May 25, 2006

Related U.S. Application Data
(60) Provisional application No. 60/684,760, filed on May 26, 2005.

(51) Int. Cl. G05D 16/10

(52) U.S. Cl. 137/505.25

(57) ABSTRACT

A fluid pressure restricting device and system to dispense a fluid under pressure. The device, which may be coupled to a pressurized supply and to a control device, includes a piston, a housing, and a spring. The fluid may be dispensed at a pressure determined according to a dimension of the piston and the spring force.

### CROSS-REFERENCE TO RELATED APPLICATION

This application claims the benefit of U.S. Provisional Patent Application Ser. No. 60/684,760, filed May 26, 2005, titled “Fluid Pressure Restricting Valve” to Carter, the disclosure of which is expressly incorporated by reference herein in its entirety.

### BACKGROUND AND SUMMARY OF THE INVENTION

The present invention relates generally to a fluid pressure restricting system. More particularly, the present invention relates to a fluid pressure restricting device or valve which restricts or regulates the pressure of a fluid, such as a gas or liquid including air and water, being dispensed from a fluid source.

Some pressure regulators utilize a diaphragm or a piston in combination with a coil spring to open and close a separate valve mechanism. The valve typically consists of a rubber poppet or other type of seal with a second spring (valve spring) to hold the poppet or seal in place. The valve is opened and closed by movement of the piston or diaphragm when it comes in contact with the poppet or seal. The opening and closing of the valve restricts the input pressure to achieve a secondary pressure at an output port. Typically, the secondary pressure is a percentage of the input pressure. The amount of pressure restriction is determined by the design. The piston or diaphragm movement is achieved by balancing the position thereof between the force of the adjustment spring and the force of the secondary pressure.

In accordance with one aspect of the present invention, there is provided a fluid pressure restricting system to restrict the pressure of a fluid. The system includes a housing including an inner surface that defines an interior, an input and an output, and a piston, including a longitudinal axis, disposed within the interior of the housing. The piston includes a first portion having a first dimension substantially perpendicular to the longitudinal axis and a second portion having a second dimension, substantially perpendicular to the longitudinal axis, the second dimension being different than the first dimension. A spring is disposed between the inner surface of the housing and the second portion. A pressure source, to supply a supply pressure, is coupled to the input of the housing. A control device is coupled to the output of the housing.

Pursuant to another aspect of the present invention there is provided a method of manufacturing a fluid pressure restricting valve comprising the steps of: forming a piston, including a first portion having a first diameter, a second portion having a second diameter, and an orifice disposed through the first portion and the second portion to provide fluid communication therethrough; selecting a spring; placing the piston in a preformed cavity; placing the spring in the preformed cavity; operatively coupling the preformed cavity to a pressure source having a fluid contained therein; and operatively coupling the preformed cavity to a control device, to control release of the fluid from the valve at a pressure.

### BRIEF DESCRIPTION OF THE DRAWINGS

A detailed description particularly refers to the accompanying figures in which:

FIG. 1 illustrates a cross-sectional view of one embodiment of a fluid pressure restricting system of the present invention including a fluid pressure restricting device having a housing and a piston.

FIG. 2 illustrates an alternative embodiment of the fluid pressure restricting device illustrated in FIG. 1.

FIG. 3 illustrates an alternative embodiment of the fluid pressure restricting device illustrated in FIG. 1.

### DETAILED DESCRIPTION OF THE DRAWINGS

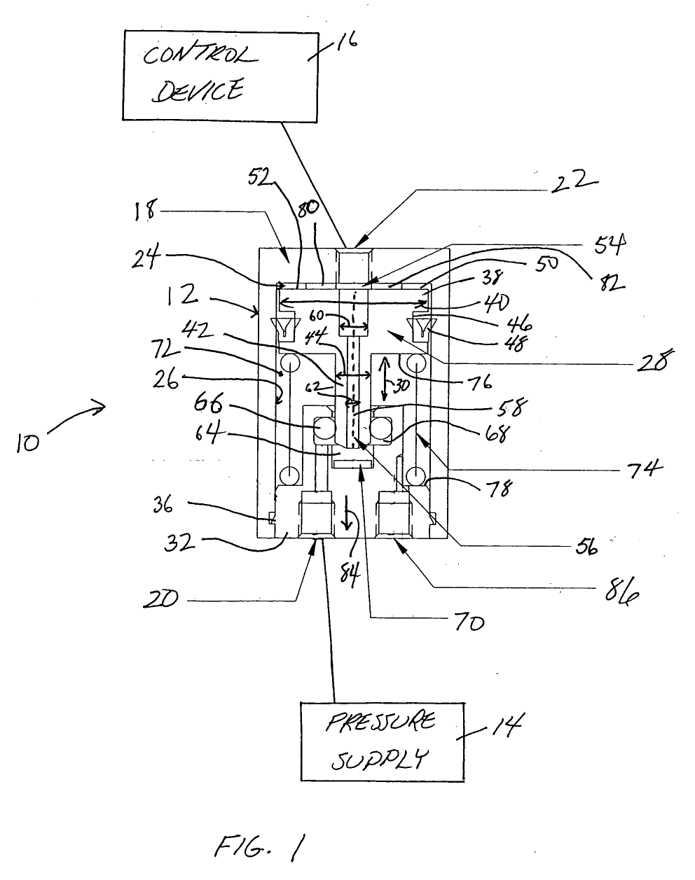

FIG. 1 illustrates a fluid pressure restricting system 10 of the present invention. The fluid pressure restricting system 10 includes a fluid pressure restricting device 12 coupled to a pressure supply 14 and to a control device 16. The fluid restricting device 12 includes a body or housing 18 including an input or supply port 20 and an output port 22. The input or supply port 20 is coupled to the pressure supply 14 while the output port 22 is coupled to the control device 16.

The body 18 includes a central cavity 24, which may be cylindrical, defined by interior wall(s) 26 of the housing 18. A piston 28, disposed within the cavity 24, moves in a direction 30. While a cylindrical piston is illustrated, other configurations are within the scope of the present invention. A cover 32, which may be removable, is disposed at one end of the housing 18 to enable the piston 28 to be placed within the cavity 24. The cover 32 defines the input port 20. The cover 32 further includes a protrusion 36. The protrusion 36 forms a seal with the interior wall 26 at the location of the cover 32 such that the cavity 24 is further defined by the housing 18 and the cover 32.

The central cavity of the body 18 slidingly accepts the piston 28. The piston 28 includes a stepped piston having a first portion 38, having a first diameter 40, and a second portion 42 having a second diameter 44. The first portion 38 includes a groove 46 defined to receive a U-cup seal 48 as illustrated.

The first portion 38 fits within the cylindrical central cavity 24 of the body 18. The dimension 40 of the first portion 38 is slightly less than the interior dimension of the central cavity 24 such that the piston 28 moves freely within the cavity in the direction 30. The U-cup seal 48 at the groove 46 of the piston 28 provides a seal such that an upper portion 50 of the central cavity 24 is defined between a top surface 52 of the piston 28 and an interior wall of the body or housing 18. While a U-cup seal is preferred, other types of seals are also possible including an O-ring seal.

The piston 28 includes an orifice or aperture 54 which is located along a central long axis 56 of the piston 28. The central long axis 56 defines a channel 58 which passes through the first portion 38 and through the second portion 42. The channel 56 includes a first dimension 60 and a second dimension 62. While the first dimension 60 is larger than the second dimension 62, it is within the scope of the present invention for the first dimension 60 and the second dimension 62 to be of the same size.

The cover 32, which includes the supply port 20, also includes a cavity 64 defined to receive the second portion 42 of the piston 28. The second portion 42 extends into the cavity 64 where the second portion contacts an O-ring seal 66 which is disposed in a groove 68 defined within the cavity 64. Also disposed within the cavity 64 is a seal 70 which during operation of the present invention seals off the channel 56 to be described later herein. The seal 70 is fixed to the cavity 64 by an adhesive or other known methods or mechanisms of adhering.

Disposed within a second portion 72 of the central cavity 24 is a spring 74. The spring is located adjacent to the second portion 42 where the second portion is inserted through at least a portion of the spring. One end of the spring 74 contacts a surface 76 of the first portion 38 and the other end of the spring 74 contacts a surface 78 of the cover 32. The spring 74, which may include a coil spring, includes a spring force which controls movement of the piston 28 in the direction 30. When no pressure is applied to the device 12, the spring 74 holds the piston 28 in a position as illustrated where a first protrusion 80 and a second protrusion 82 coupled to the first portion 38 contact the interior of the housing 18. While two protrusions are shown, one protrusion or more may be incorporated into or on the top surface 52. The protrusion(s) reduce the likelihood of or prevent the surface 52 from adhering to the facing interior wall of the cavity 24.

In this position, also known as the at rest position, the spring 74 holds the piston 28 in the illustrated position such that the channel 56 does not contact the seal 70. Consequently, a supply path is made for supplying pressurized fluid provided by the pressure supply 14 to the output 22. Pressurized fluid moves through the input port 20, through the cavity 64, through the channel 56, and up to the output port 22. Typically a customer supplied control device 16 closes off the output port 22. The control device may include a cap, a nozzle, or other devices to open and close the output port 22. When the control device 16 closes off output port 22 and a pressurized fluid is supplied at the input or supply port 20, the pressurized fluid builds pressure in the first portion 50 of the central cavity 24 until the resulting force overcomes the force of the spring 74. This force causes the piston 28 to move in a direction 84 whereby closing off the channel 56. The cover 32 includes a relief port 86 which is open to atmosphere such that when the piston 28 moves in the direction 84, pressure built up within the second portion 72 of the cavity 24 is released.

The pressure at which the piston 28 shifts or moves in the direction 84 may be determined by the diameter 40 of the first portion 38, as well as the spring force of the spring 74. The pressure at the output port 22 is selected based on a desired output pressure and by selecting the diameter 40, the spring force of the spring 72, and a known input pressure from the pressure supply 14. When the spring force is selected to be stronger, a higher pressure at the output port 22 results. When the spring force is selected to be weaker, the pressure at the output port 22 is lessened. The pressure at the output port 22 is a percentage of the pressure at the input port 20.

Once the output port 22 is opened through actuation of the control device 16, the pressure in the chamber 50 decreases, thereby reducing the force on the piston 28. This opening of the output port 22 allows the force of the spring 74 to shift the piston 28 to its original position. The channel 56 is again opened and pressure flows to the upper port 54.

The present device does not include a separate valve mechanism (valve and valve spring) controlled by an adjustment spring and diaphragm or piston. The piston 28 of the present invention is balanced within the cavity 24 by the spring 74 and the pressure forces under control of opening and closing the output port 22. This design controls the secondary pressure to the output port 22.

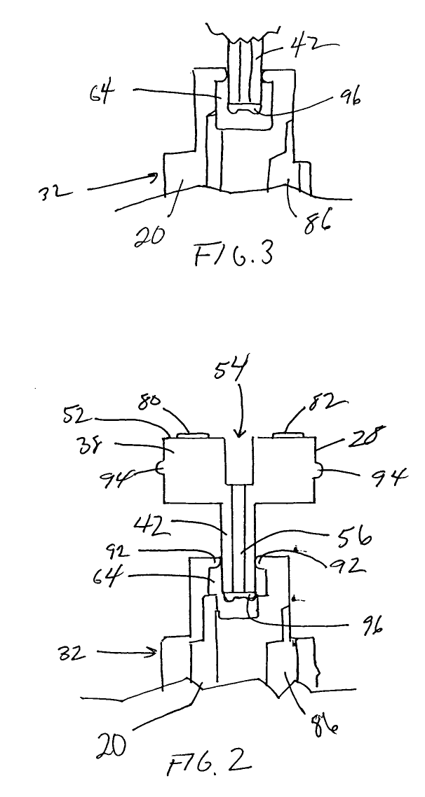

FIG. 2 illustrates an alternative embodiment of the fluid pressure restricting device of FIG. 1. In this embodiment, the housing 18 and the spring 72 are not shown. The cover 32 in this embodiment includes the cavity 64 but the O-ring seal 66 is not necessary. The cover 32 has been formed to include as part of the cover 32, a seal 92 formed thereon. The cover 32 may be formed using an injection molding process where the seal 92 may be molded to or as part of the cover 32. In addition, the seal 92 may be formed of rubber or plastic. Rubber sealing material may be vulcanized or otherwise adhered to a plastic or metal cover 32. The cover also may be molded from a single type of material in a single step molding process such that the seal 92 and the cover 32 are a unitary piece.

In the embodiment of FIG. 2, the piston 28 has been formed to include a seal 94 adhered to the first portion 28. As previously described for the cover 32, the seal 94 coupled to the piston 28 may be formed using an injection molding process where the seal 94 is molded to or is made part of the piston 28. Rubber sealing material can be vulcanized or otherwise adhered to the materials of the piston 28 which may include plastic or metal resulting in a unitary piece.

Furthermore, with respect to the embodiment of FIG. 2, the cover 32 does not include the seal 70 as previously described in FIG. 1. Instead the piston 28 has been formed to include a seal 96 disposed at the orifice 56. The seal 96 can be formed as previously described for the seal 94. The seal 96 includes an aperture open to the channel 58.

FIG. 3 illustrates an alternative embodiment of the pressure restricting device of FIG. 2 wherein the cover 32 is modified with respect to the cover 32 of FIG. 2. As illustrated in this embodiment, the cavity 64 is formed such that it does not include a portion to fittingly receive the second portion 42 of the piston 28 as previously described for FIGS. 1 and 2.

The present invention not only includes the system of FIG. 1, which includes a housing 18, a cover 32 and a piston 28, but also includes the embodiments of FIG. 2 and FIG. 3 where the housing 18 is supplied by a customer to receive the cover 32, the piston 28, and the spring 72, or the piston 28 and the spring 74. Consequently, the present device does not need to be mounted externally to a larger system which may include brackets and screws. With the present invention, the piston 28, the spring 74, and the cover 32 may be supplied to a customer as a sub-assembly. The customer then places the sub-assembly into the pre-machined or pre-formed cavity of a supplied housing. Because the present device includes low cost and few moving parts, it is less expensive to replace than other known pressure regulators.

A replacement can be made by removing the sub-assembly and placing a replacement sub-assembly into the cavity. Consequently, machine downtime may be reduced. Likewise, no or very little troubleshooting may be required since the sub-assembly may be removed and thrown away. Since the present design is not easily tampered with, the amount of pressure restriction or reduction cannot be inadvertently or easily changed. Consequently, the present invention provides a degree of safety. The present invention can also be used as an in-line regulator where the sub assembly is supplied with the body and all of the components as described are installed as a complete assembly.

All though the invention has been described which reference to the preferred embodiments, variations and modifications exist within the scope and spirit of the present invention as described and defined in the following claims.

1. A fluid pressure restricting system to restrict the pressure of a fluid comprising:
a housing including an inner surface that defines an interior, an input and an output;
a piston, including a longitudinal axis, disposed within the interior of the housing, the piston including a first portion having a first dimension substantially perpendicular to the longitudinal axis and a second portion having a second dimension, substantially perpendicular to the longitudinal axis, the second dimension being different than the first dimension;
a pressure source, to supply a supply pressure, coupled to the input of the housing;
a spring, disposed between the inner surface of the housing and the second portion; and
a control device, coupled to the output of the housing.

2. The fluid pressure restricting system of claim 1, wherein the first portion comprises a cylindrical portion with the first dimension being a diameter.

3. The fluid pressure restricting system of claim 2, wherein the second portion comprises a cylindrical portion with the second dimension being a diameter.

4. The fluid pressure restricting system of claim 3, wherein the piston moves in the interior of the housing along the longitudinal axis.

5. The fluid pressure restricting system of claim 4, wherein the piston includes a channel disposed through the piston and along the longitudinal axis.

6. A method of manufacturing a fluid pressure restricting valve comprising the steps of:
forming a piston, including a first portion having a first diameter, a second portion having a second diameter, and an orifice disposed through the first portion and the second portion to provide fluid communication therethrough;
selecting a spring;
placing the piston in a preformed cavity;
placing the spring in the preformed cavity;
operatively coupling the preformed cavity to a pressure source having a fluid contained therein; and
operatively coupling the preformed cavity to a control device, to control release of the fluid from the valve at a pressure.

7. The method of claim 6, wherein the placing the spring step includes placing the spring adjacent the second portion of the piston.

8. The method of claim 7, wherein the forming step includes forming the piston with the first diameter selected to determine the pressure of the fluid released from the valve.

9. The method of claim 8, wherein the selecting step includes selecting the spring to have a spring force selected to determine the pressure of the fluid released from the valve.
